(19) United States
(12) Patent Application Publication
(10) Pub. No.: US 2016/0355417 A1
(43) Pub. Date: Dec. 8, 2016

(54) ALTERNATING CURRENT ELECTROLYSIS METHOD FOR LIQUID

(71) Applicant: DONCREVE CO., LTD., Tokyo (JP)

(72) Inventor: Shinkichi SATO, Higashimurayama-shi (JP)

(73) Assignee: DONCREVE CO., LTD., Tokyo (JP)

(21) Appl. No.: 14/733,039

(22) Filed: Jun. 8, 2015

(51) Int. Cl. C02F 1/461

(52) U.S. Cl. CPC C02F 1/461; C02F 2303/22

(57) ABSTRACT

In order to prevent an efficiency of lowering an oxidation-reduction potential of a liquid from being degraded when scales such as Ca contained in the liquid adsorb to an electrode and the liquid is subjected to electrolysis while the scales and the like adsorb to the electrode, provided is an alternating current electrolysis method for a liquid, including: arranging a pair of alternating electrodes each formed of a metal that lowers an oxidation-reduction potential and a first ground electrode formed of at least a metal in a liquid contained in a liquid tank; and controlling so that an alternating current is applied between the pair of alternating electrodes and an alternating current is intermittently applied from a ground potential to the first ground electrode.

### BACKGROUND OF THE INVENTION

1. Field of the Invention

The present invention relates to a method of electrolyzing a liquid such as sewage water, as typified by lake water, river water, or industrial wastewater, or mineral water or drinking water with an alternating current.

2. Description of the Related Art

Hitherto, a liquid such as sewage water, as typified by lake water, river water, or industrial wastewater, or mineral water or drinking water has been generally reformed and improved by causing a chemical reaction to occur through use of chemicals such as various reducing agents.

As a method of reforming and improving those liquids without using chemicals such as reducing agents, for example, an alternating current electrolysis method for a liquid has been generally used. The alternating current electrolysis method for a liquid involves arranging a ground electrode between a first electrode and a second electrode, the first electrode and the second electrode being formed of a metal that lowers an oxidation-reduction potential of a liquid, and applying an alternating current between the first electrode and the second electrode to electrolyze the liquid, thereby lowering the oxidation-reduction potential of the liquid.

The method involving causing a chemical reaction to occur through use of chemicals such as reducing agents has problems in that it is necessary to prepare expensive chemicals such as reducing agents, it takes human labor due to the use of the chemicals and the like, pollution may be caused, it takes labor and high cost, and the like.

Further, the related-art alternating current electrolysis method for a liquid has a problem in that scales such as Ca contained in a liquid adsorb to an electrode at a time of alternating current electrolysis of the liquid, and when the liquid is subjected to electrolysis while the scales and the like adsorb to the electrode, the efficiency of lowering the oxidation-reduction potential of the liquid is degraded.

### SUMMARY OF THE INVENTION

The present invention has been made so as to solve the above-mentioned problems of the related-art alternating current electrolysis method for a liquid, and it is an object of the present invention to continuously maintain the efficiency of subjecting a liquid to electrolysis in a satisfactory state by eliminating the necessity of preparing expensive chemicals such as reducing agents so as to reduce labor and cost and by preventing the degradation of the effect of lowering an oxidation-reduction potential of the liquid, that is, the effect of generating hydrogen.

According to one embodiment of the present invention, there is provided an alternating current electrolysis method for a liquid, including: arranging a pair of alternating electrodes each formed of a metal that lowers an oxidation-reduction potential and a first ground electrode formed of at least a metal in a liquid contained in a liquid tank; and controlling so that an alternating current is applied between the pair of alternating electrodes, and an alternating current is intermittently applied from a ground potential to the first ground electrode.

In the alternating current electrolysis method for a liquid according to one embodiment of the present invention, the pair of alternating electrodes each formed of a metal that lowers an oxidation-reduction potential and the first ground electrode formed of at least a metal are arranged in a liquid contained in a liquid tank, an alternating current is applied between the pair of alternating electrodes, and an alternating current is intermittently applied from a ground potential to the first ground electrode.

Therefore, there is an effect that it is not necessary to prepare expensive chemicals such as reducing agents. In addition, hydrogen for reforming a liquid to lower the oxidation-reduction potential of the liquid may be generated sufficiently, and the efficiency of generating the hydrogen may be prevented from being degraded.

Thus, the electrolysis of the liquid may be continuously maintained with satisfactory efficiency.

In the alternating current electrolysis method for a liquid according to one embodiment of the present invention, the pair of alternating electrodes have a rectangular mesh shape. Therefore, the usage amount of a metal in the pair of alternating electrodes may be reduced, and the efficiency of the alternating current electrolysis of lowering the oxidation-reduction potential of the liquid, that is, increasing the generation amount of hydrogen may be enhanced, with the result that a time period required for the alternating current electrolysis may be shortened.

The detailed mechanism for the foregoing has not been clarified, but it is presumed that electrons are allowed to move smoothly by forming the pair of alternating electrodes into a mesh shape instead of a plate shape.

According to one embodiment of the present invention, the alternating current applied to the pair of alternating electrodes may be controlled for a frequency separately between the alternating electrodes, and hence the alternating current electrolysis of further increasing the generation amount of hydrogen may be performed efficiently and smoothly.

According to one embodiment of the present invention, the alternating current is applied to the first ground electrode intermittently with the alternating current applied to any one of the pair of alternating electrodes.

Therefore, the alternating current is intermittently applied to the first ground electrode by being switched by a timer circuit, with the result that the first ground electrode may be cleaned automatically, and white adhering substances and scales such as Ca adhering to the first ground electrode may be removed.

Further, the scales and the like maybe prevented from adhering to the first ground electrode, and hence the efficiency of the alternating current electrolysis may be maintained more satisfactorily. The electrolysis of the liquid is reduced while the first ground electrode is being cleaned, but the electrolysis of the liquid may be continued.

According to one embodiment of the present invention, the alternating current is intermittently applied to the first ground electrode for 1/10 to 1/1,000 of a time period for grounding.

Therefore, the first ground electrode may be cleaned automatically, and white adhering substances and scales such as Ca adhering to the first ground electrode may be removed within a short time period.

The electrolysis of the liquid is reduced while the first ground electrode is being cleaned, but the electrolysis of the liquid may be continued.

In the alternating current electrolysis method for a liquid according to one embodiment of the present invention, the first ground electrode has one of a circular column shape and a rectangular column shape. Therefore, the first ground electrode maybe manufactured easily, and scales such as Ca may be prevented from adhering to a surface of the first ground electrode during the alternating current electrolysis of the liquid.

In particular, when the first ground electrode is formed into a circular column shape, scales may be prevented from adhering to a surface of a circular column of the first ground electrode. Further, when scales adhering to the first ground electrode are removed by cleaning, the scales may be removed by cleaning easily and smoothly because the first ground electrode has one of the circular column shape and the rectangular column shape, and there are no obstacles around the first ground electrode.

An alternating current electrolysis method for a liquid according to one embodiment of the present invention includes: arranging a pair of alternating electrodes each formed of a metal that lowers an oxidation-reduction potential and a first ground electrode formed of at least a metal in a liquid contained in a liquid tank, and arranging a second ground electrode (reference numeral 18 shown in FIG. 4) around the pair of alternating electrodes and the first ground electrode; and applying an alternating current between the pair of alternating electrodes, and applying an alternating current intermittently from a ground potential to the first ground electrode and the second ground electrode. Therefore, the efficiency of the alternating current electrolysis may be further enhanced.

In the alternating current electrolysis method for a liquid according to one embodiment of the present invention, the pair of alternating electrodes have a rectangular mesh shape. Therefore, the usage amount of a metal in the pair of alternating electrodes may be reduced, and the efficiency of the alternating current electrolysis of lowering the oxidation-reduction potential of the liquid, that is, increasing the generation amount of hydrogen may be enhanced, with the result that a time period required for the alternating current electrolysis may be shortened.

The detailed mechanism for the foregoing has not been clarified, but it is presumed that electrons are allowed to move smoothly by forming the pair of alternating electrodes into a mesh shape instead of a plate shape.

In the alternating current electrolysis method for a liquid according to one embodiment of the present invention, the first ground electrode has one of a circular column shape and a rectangular column shape. Therefore, the first ground electrode maybe manufactured easily, and scales such as Ca may be prevented from adhering to a surface of the first ground electrode during the alternating current electrolysis of the liquid.

In the alternating current electrolysis method for a liquid according to one embodiment of the present invention, the second ground electrode has one of a cylindrical shape and a rectangular shape, and hence the efficiency of the alternating current electrolysis may be further enhanced.

In the alternating current electrolysis method for a liquid according to one embodiment of the present invention, the first ground electrode and the second ground electrode are removably secured to each other with a headed screw at a lower end of the first ground electrode and a central bottom wall of the second ground electrode. Therefore, the headed screw may be removed or mounted easily, and the first ground electrode and the second ground electrode that are removed and disassembled may be cleaned easily. Further, only defective one of the first ground electrode and the second ground electrode may be replaced by a new electrode.

In the alternating current electrolysis method for a liquid according to one embodiment of the present invention, the first ground electrode and the second ground electrode are removably secured to each other with a plate spring so that a lower end of the first ground electrode is inserted into a through hole having the plate spring divided into a plurality of pieces continuously on a central bottom wall of the second ground electrode. Therefore, the headed screw may be removed or mounted easily, and the first ground electrode and the second ground electrode that are removed and disassembled may be cleaned easily. Further, only defective one of the first ground electrode and the second ground electrode may be replaced by a new electrode.

### BRIEF DESCRIPTION OF THE DRAWINGS

FIG. 1 is an electric circuit diagram according to a first embodiment of the present invention.

FIG. 2 is an enlarged plan view of an alternating electrode.

FIG. 3 is a graph for showing a fluctuation of a control frequency from a control circuit.

FIG. 4 is an electric circuit diagram according to a second embodiment of the present invention.

FIG. 5 is an enlarged perspective view of another first ground electrode and another second ground electrode.

FIG. 6 is an enlarged perspective view of still another first ground electrode and still another second ground electrode.

FIG. 7 is a vertical sectional view of FIG. 6.

### DETAILED DESCRIPTION OF THE PREFERRED EMBODIMENTS

In an alternating current electrolysis method for a liquid of the present invention, a pair of alternating electrodes each formed of a metal that lowers an oxidation-reduction potential and a first ground electrode formed of at least a metal are arranged in a liquid contained in a liquid tank of an alternating current electrolysis device for a liquid, an alternating current is applied between the pair of alternating electrodes, and an alternating current is intermittently applied from a ground potential to the first ground electrode.

[First Embodiment]

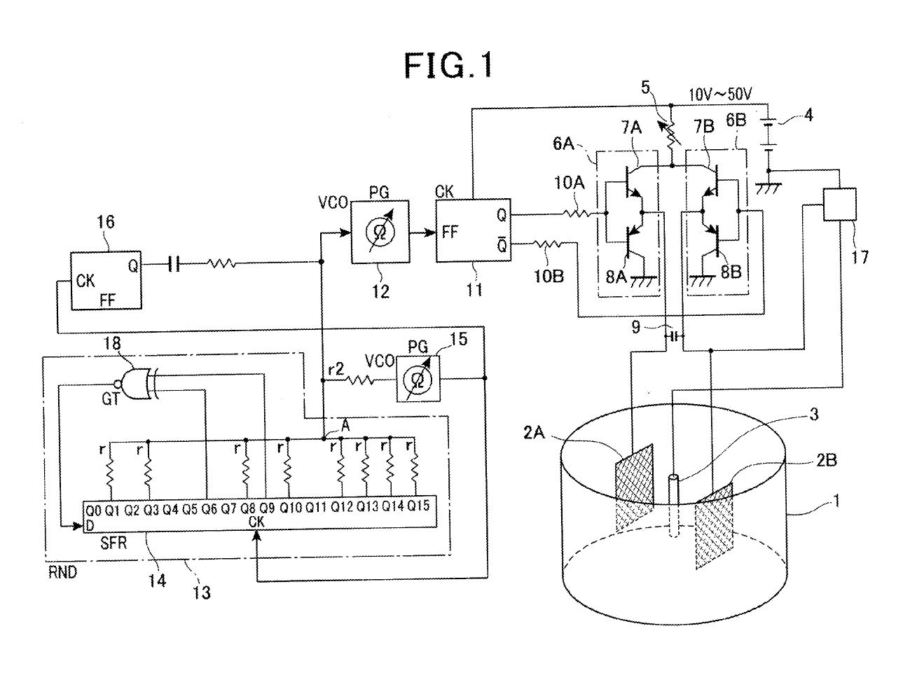

In an alternating current electrolysis method for a liquid according to a first embodiment of the present invention, as illustrated in a circuit diagram of FIG. 1, a first ground electrode 3 having a circular column shape is arranged between a pair of alternating electrodes (one of the alternating electrodes is an alternating electrode 2A, and the other is an alternating electrode 2B) in a water tank 1.

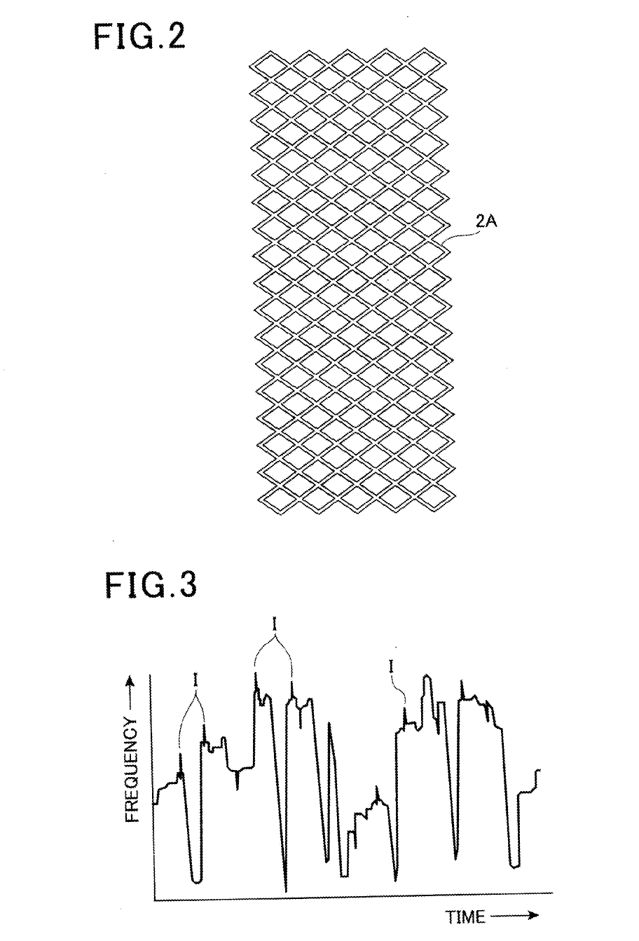

As illustrated in FIG. 2, the one alternating electrode 2A has a rectangular mesh shape, and the other alternating electrode 2B also has a rectangular mesh shape. The one alternating electrode 2A and the other alternating electrode 2B convert a direct current from a direct-current power supply 4 via a variable resistor 5 into an alternating current having a high frequency, and high-frequency switches 6A and 6B are respectively connected to the alternating electrodes 2A and 2B.

The high-frequency switches 6A and 6B respectively include transistors 7A and 7B and transistors 8A and 8B and are respectively connected to the pair of alternating electrodes 2A and 2B through a capacitor 9.

A high-frequency switching command circuit 11 is connected to the high-frequency switches 6A and 6B through resistors 10A and 10B, and a high-frequency oscillation circuit 12 containing a voltage controlled variable oscillator (VOC) that has an oscillation frequency changing in response to a control signal is connected to the high-frequency switching command circuit 11.

A control circuit 13 containing a random voltage generator is connected to the high-frequency oscillation circuit 12.

The control circuit 13 contains a shift register (SFR) 14 storing random number information, a random signal generator, and a gate (GT) 18.

Resistors r contained in the shift register (SFR) 14 are connected to the high-frequency oscillation circuit 12 through a connection point A, and the resistors r contained in the shift register (SFR) 14 are connected to a pulse generator (PG) 15 through the connection point A and a resistor r2.

Further, the pulse generator (PG) 15 is connected to the control circuit 13 and is also connected to a flip flop circuit (FF) 16.

The flip flop circuit (FF) 16 is connected to the high-frequency oscillation circuit 12.

A timer circuit 17 is connected to the first ground electrode 3 and is connected to the direct-current power supply 4 and the one high-frequency switch 6B.

Each circuit and the like in the alternating current electrolysis method for a liquid according to the first embodiment is described in detail.

In the control circuit 13, the shift register (SFR) 14 has a 16-stage configuration, and information stored therein can be read from terminals Q0 to Q15 arranged in parallel. In the shift register (SFR) 14, when a signal output from one even-numbered stage, for example, a sixth stage Q6 and a signal output from the other odd-numbered stage, for example, a ninth stage Q9 are respectively input, those signals are input to the lowest-level stage Q0 through a terminal D.

Such an input of information is sequentially repeated, and thus random number information is stored in the shift register (SFR) 14.

The control circuit 13 outputs a control signal having a voltage value that variously changes in accordance with a random signal that is generated from the random voltage generator contained in the control circuit 13 based on the stored random information.

The pulse generator (PG) 15 receives a voltage at the connection point A through the resistor r2 based on a signal change of the voltage value from the control circuit 13, and generates a pulse that repeatedly fluctuates based on the random number information in the voltage controlled variable oscillator (VOC) contained in the pulse generator 15 in accordance with the control signal.

Thus, the control circuit 13 outputs a voltage of a random signal, and the pulse generator (PG) 15 and the high-frequency oscillation circuit 12 are oscillated with the voltage to output a pulse.

The pulse generator (PG) 15 and the high-frequency oscillation circuit 12 serve to output a pulse in the same manner, but the actuations thereof are different. Therefore, for example, the high-frequency oscillation circuit 12 outputs a pulse of 30 KHz, and the pulse generator (PG) 15 outputs a pulse of 5 KHz.

The pulse signal output from the high-frequency oscillation circuit 12 is finally applied as a voltage of from 10V to 50 V to the alternating electrodes 2A and 2B through the high-frequency switching command circuit 11, and thus alternating current electrolysis is performed.

Further, in this state, the pulse signal output from the pulse generator (PG) 15 is input to the control circuit 13 to generate a further different random voltage, and similarly a pulse is generated from the flip flop circuit 16 and input to the high-frequency oscillation circuit 12.

When those different pulses are suddenly and instantaneously input to the high-frequency oscillation circuit 12, an impulse wave (IMPULSE) is generated as in a frequency “I” shown in FIG. 3.

The impulse wave serves to remove the scales adhering to the alternating electrodes 2A and 2B to enhance the electrolysis efficiency and suppress the adhesion of the scales to the first ground electrode 3.

The signal thus generated is transmitted from the high-frequency oscillation circuit 12 to the high-frequency switching command circuit 11 and is continuously transmitted alternately to the high-frequency switches 6A and 6B. Then, the high-frequency switches 6A and 6B are turned ON/OFF at a high cycle, with the result that a high-frequency alternating current that changes randomly is formed and continuously applied alternately to the pair of alternating electrodes 2A and 2B arranged in a liquid of the water tank 1.

When the alternating current is continuously applied alternately between the one alternating electrode 2A and the other alternating electrode 2B of the pair of alternating electrodes to electrolyze the liquid with the alternating current while the first ground electrode 3 is grounded, the liquid is subjected to a chemical change of “2H₂O+2e=2OH⁻+H2” between the alternating electrodes 2A and 2B, and the oxidation-reduction potential of the liquid is lowered.

It is confirmed with the naked eyes that when the oscillated high frequency is changed as described above, the amount of the scales adhering to the surfaces of the alternating electrodes 2A and 2B is significantly small, and air bubbles such as hydrogen generated by the alternating electrodes 2A and 2B become minute, compared to the case where the oscillated high frequency is not changed. Thus, the oxidation-reduction potential, that is, the generated hydrogen can be kept in a stable state over a long time period, and the treated liquid can be stored for a long time period due to the generation of hydrogen.

The timer circuit 17 is generally connected to the first ground electrode 3.

When the first ground electrode 3 is cleaned, the electric potential of the first ground electrode 3 is set to the same alternating potential as that of the other alternating electrode 2B intermittently from the set ground potential by switching to the other alternating electrode 2B of the pair of alternating electrodes with a pulse signal from the timer circuit 17.

Thus, due to the switching of the timer circuit 17, the first ground electrode 3 is cleaned automatically to remove the scales adhering thereto, and scales and the like are further prevented from adhering to the first ground electrode 3, with the result that the efficiency of the alternating current electrolysis can be maintained further satisfactorily.

The electrolysis of the liquid is reduced while the first ground electrode 3 is being cleaned, but the electrolysis of the liquid is continued.

[Second Embodiment]

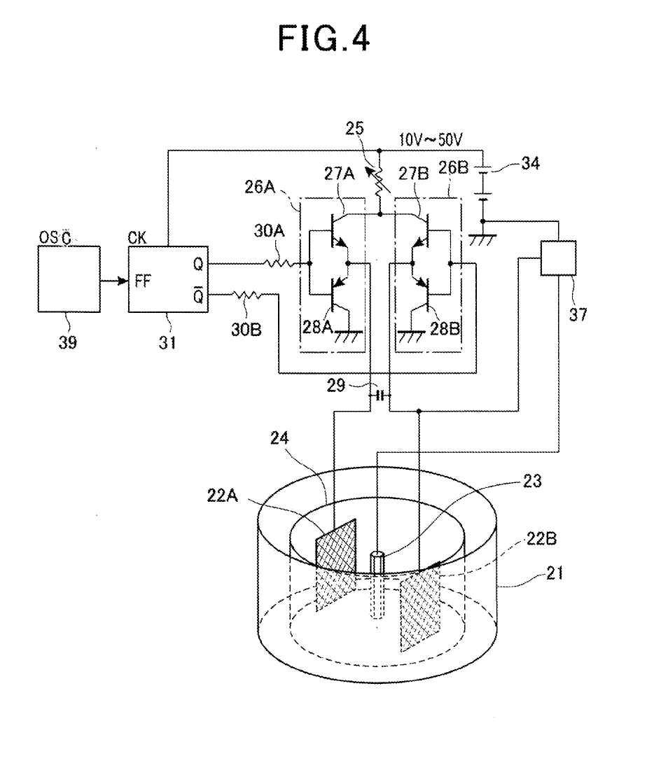

An alternating current electrolysis method for a liquid according to a second embodiment of the present invention is as illustrated in a circuit diagram of FIG. 4.

In the second embodiment, a first ground electrode 23 having a rectangular column shape is arranged between one alternating electrode 22A and the other alternating electrode 22B of a pair of alternating electrodes in a water tank 21.

A second ground electrode 24 having a cylindrical shape is arranged around the pair of alternating electrodes 22A and 22B and the first ground electrode 23 in the water tank 21. A direct-current power supply 34 is arranged.

In the first embodiment, the circuit for controlling a frequency is described. However, in the second embodiment, the circuit for controlling a frequency is omitted, and an alternating current oscillator (OSC) 39 is connected instead. The other circuits are the same as those of the first embodiment, and hence the repeated descriptions thereof are omitted.

Note that, in the second embodiment, the circuit for controlling a frequency in the first embodiment may be used instead of the alternating current oscillator (OSC) 39.

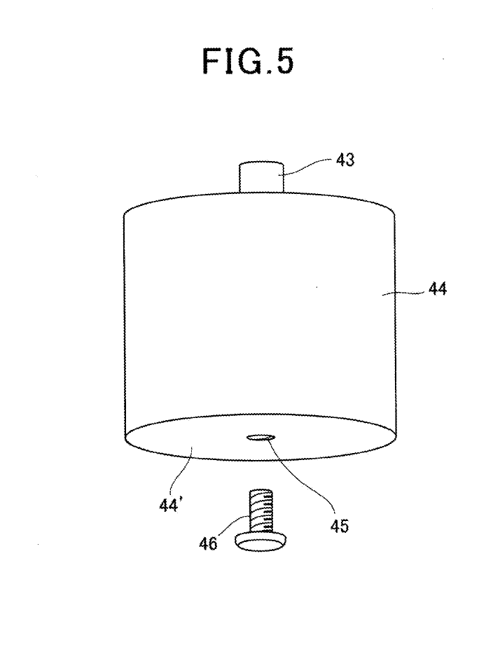

In the alternating current electrolysis method for a liquid according to the second embodiment, the alternating current oscillator (OSC) 39 or the like is connected, and in particular, the second ground electrode 24 having a cylindrical shape is arranged around the pair of alternating electrodes 22A and 22B and the first ground electrode 23. Compared to the second embodiment, an alternating current electrolysis method for a liquid illustrated in FIG. 5 is improved only in that a first ground electrode 43 and a second ground electrode 44 are removably secured to each other. The other circuits and the drawing are the same as those of the second embodiment, and hence the repeated descriptions thereof are omitted.

As illustrated in FIG. 5, a screw hole 45 is formed in a central bottom wall 44′ of the second ground electrode 44, and an internal thread for screws is formed at a lower end of the first ground electrode 43.

A headed screw 46 is inserted into the screw hole 45 formed in the central bottom wall 44′ of the second ground electrode 44, and then an external thread of the headed screw 46 is rotated to be inserted into the internal thread for screws of the first ground electrode 43. Thus, the first ground electrode 43 and the second ground electrode 44 are removably secured to each other with the headed screw 46.

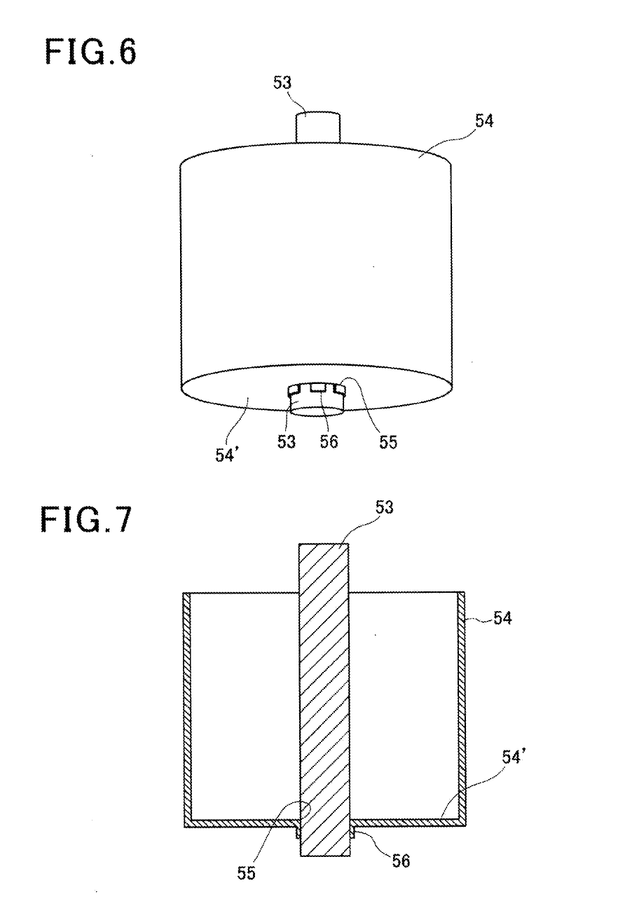

In the alternating current electrolysis method for a liquid according to the second embodiment, the alternating current oscillator (OSC) 39 or the like is connected, and in particular, the second ground electrode 24 having a cylindrical shape is arranged around the pair of alternating electrodes 22A and 22B and the first ground electrode 23. Compared to the second embodiment, an alternating current electrolysis method for a liquid illustrated in FIG. 6 and FIG. 7 is improved only in that a first ground electrode 53 and a second ground electrode 54 are removably secured to each other. The other circuits and the drawing are the same as those of the second embodiment, and hence the repeated descriptions thereof are omitted.

As illustrated in FIG. 6 and FIG. 7, the first ground electrode 53 is inserted into a through hole 55 having a plate spring 56 divided into six pieces extending downwardly in a center portion of a central bottom wall 54′ of the second ground electrode 54, and the first ground electrode 53 and the second ground electrode 54 are removably secured to each other with the plate spring 56 connected the second ground electrode 54.

The plate spring 56 is formed of the six divided plate spring pieces in the center portion of the central bottom wall 54′. The six divided plate spring pieces are formed radially along an outer shape of the first ground electrode 53 so as to be connected to the central bottom wall 54′ of the second ground electrode 54 in a substantially circular shape and extend downwardly so as to be slightly curved to an inner side of the through hole 55.

What is claimed is:

1. An alternating current electrolysis method for a liquid, comprising:
arranging a pair of alternating electrodes each formed of a metal that lowers an oxidation-reduction potential and a first ground electrode formed of at least a metal in a liquid contained in a liquid tank; and
applying an alternating current between the pair of alternating electrodes, and applying an alternating current intermittently from a ground potential to the first ground electrode.

2. An alternating current electrolysis method for a liquid according to claim 1, wherein the pair of alternating electrodes have a rectangular mesh shape.

3. An alternating current electrolysis method for a liquid according to claim 1, wherein the alternating current applied to the pair of alternating electrodes is controlled for a frequency separately between the pair of alternating electrodes.

4. An alternating current electrolysis method for a liquid according to claim 1, wherein the alternating current is applied to the first ground electrode intermittently with the alternating current applied to any one of the pair of alternating electrodes.

5. An alternating current electrolysis method for a liquid according to claim 1, wherein the alternating current is intermittently applied to the first ground electrode for 1/10 to 1/1,000 of a time period for grounding.

6. An alternating current electrolysis method for a liquid according to claim 1, wherein the first ground electrode has one of a circular column shape and a rectangular column shape.

7. An alternating current electrolysis method for a liquid, comprising:
arranging a pair of alternating electrodes each formed of a metal that lowers an oxidation-reduction potential and a first ground electrode formed of at least a metal in a liquid contained in a liquid tank, and arranging a second ground electrode around the pair of alternating electrodes and the first ground electrode; and
applying an alternating current between the pair of alternating electrodes, and applying an alternating current intermittently from a ground potential to the first ground electrode and the second ground electrode.

8. An alternating current electrolysis method for a liquid according to claim 7, wherein the pair of alternating electrodes have a rectangular mesh shape.

9. An alternating current electrolysis method for a liquid according to claim 7, wherein the first ground electrode has one of a circular column shape and a rectangular column shape.

10. An alternating current electrolysis method for a liquid according to claim 7, wherein the second ground electrode has one of a cylindrical shape and a rectangular column shape.

11. An alternating current electrolysis method for a liquid according to claim 7, wherein the first ground electrode and the second ground electrode are removably secured to each other with a headed screw at a lower end of the first ground electrode and a central bottom wall of the second ground electrode.

12. An alternating current electrolysis method for a liquid according to claim 7, wherein the first ground electrode and the second ground electrode are removably secured to each other with a plate spring so that a lower end of the first ground electrode is inserted into a through hole having the plate spring divided into a plurality of pieces continuously on a central bottom wall of the second ground electrode.
